(19) United States
(12) Patent Application Publication
(10) Pub. No.: US 2005/0059388 A1
(43) Pub. Date: Mar. 17, 2005

(54) Wireless local area network security

(75) Inventors: Russell John Haines, Bristol (GB); Georgios Kalogridis, Bristol (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/896,889

(22) Filed: Jul. 23, 2004

(30) Foreign Application Priority Data
Aug. 6, 2003 (GB) 0318430.6

(51) Int. Cl. H04Q 7/20

(52) U.S. Cl. 455/422.1; 455/41.2

(57) ABSTRACT

The present invention relates to security for wireless networks, especially WLAN's and PAN's. The present invention provides a terminal which adjusts its transmission output to provide a narrow beam directed at the receiving terminal, and also adjusts the transmission power to limit the range of the beam to that of the receiving terminal.

### FIELD OF THE INVENTION

The present invention relates to security for wireless communication, and in particular although not exclusively to wireless local area networks.

### BACKGROUND OF THE INVENTION

Wireless local area networks (WLAN) are becoming increasingly popular as a way of providing communication between terminals without the need for expensive and awkward cabling; and to enable more dynamic or flexible network layouts. For example increasing numbers of businesses are installing WLAN to couple their staff terminals to the firm's IT resources. However the use of this technology increases the risk of security breaches.

Wireless LANs suffer from security weaknesses as the radio signals used to transfer data and control signals can be intercepted by third parties. This weakness can be exploited by hackers to either eavesdrop on communications across the network or to actively disrupt the functioning of the network.

Though not always employed by operators of WLAN, solutions to this problem include encryption of the traffic data travelling on the radio signals together with authentication procedures for terminals coupled to the network. Such a system is described for example in European patent application number 1178644. Hackers are able to counter these measures to some extent which leads to more sophisticated encryption and/or authentication. However this makes these systems more complex and costly.

### SUMMARY OF THE INVENTION

In general terms in a first aspect the present invention provides a wireless communication system having improved security. Preferably the system is in the form of a wireless local area network such as an IEEE 802.11 network having a number of terminals. The wireless terminals are arranged to communicate with each other using radio signals having a directed radiation pattern, preferably a narrow beam directed from the transmitting terminal to the receiving terminal. This considerably reduces the opportunities for a hacker to illegitimately interact with the wireless network by significantly reducing the coverage area of this network. Preferably the terminals are further arranged such that their transmission power is adjusted in order to reduce their transmission range to that required by the receiving terminal. Again, this further reduces the opportunity for a hacker to interface with the network by further reducing the coverage area, and in particular adapting the coverage area to the minimum required for communication between the two terminals.

This is a relatively simple measure which can be taken to improve the security of a wireless communication system, and can usefully be combined with more traditional encryption and authentication mechanisms.

In particular in one aspect the present invention provides a wireless local area network according to claim 1.

In particular, in another aspect the present invention provides a terminal according to claim 12.

In general terms in another aspect the present invention provides a method for improving the security of a wireless communication system and in particular a wireless local area network. The method comprises directing the transmission radiation patterns of the terminals according to the location of the other terminals within the network. Preferably the power of the transmission radiation is also controlled depending on the distances to the other terminals. In this way the network is arranged to have a minimum coverage area or radiation pattern in order to enable effective communication between the terminals. This reduces the opportunity for hackers to interact with the network. This is especially the case where the radiation patterns do not extend beyond a building owned or controlled by the entity operating the network.

In particular, in this other aspect the present invention provides a method for improving the security of a local area network according to claim 13.

The directed transmission radiation patterns are preferably in the form of narrow beams which may be generated in the terminals using known beam formers and antenna arrays. The radiation pattern of one or more of the terminals may further be adjusted to comprise a null or notch directed at a transmission source which is either not recognised by the network or is otherwise interfering with the network's performance.

The narrow beams are preferably limited in distance, by adjusting transmission power in the associated terminal, to that required to communicate with the other terminal. This transmission power adjustment may be implemented in the terminal using known power control mechanisms.

### BRIEF DESCRIPTION OF THE DRAWINGS

Embodiments are described with respect to the following drawings, by way of example only and without intending to be limiting, in which:

FIG. 1 shows a combined radiation pattern for a number of wireless local area networks within a house;

FIG. 2 shows the radiation patterns for the WLANs of FIG. 1 utilising an embodiment;

FIG. 3 is a schematic of an embodiment; and

FIG. 4 shows in more detail the architecture of the embodiment of FIG. 3.

### DETAILED DESCRIPTION OF THE DRAWINGS

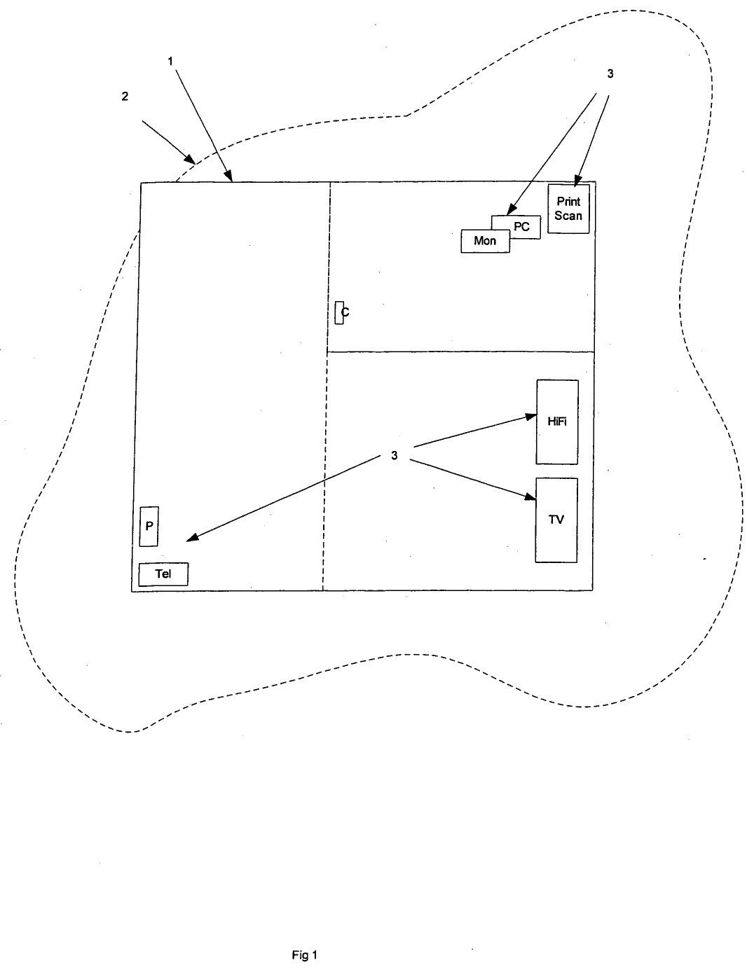

Referring to FIG. 1 a domestic dwelling or house 1 is shown which comprises a number of equipment terminals 3 capable of wireless communications and which form various wireless local area networks (WLAN) with each other. For example a PC, monitor, and printer and scanner unit communicate wirelessly with each other. Similarly a hifi unit and television unit communicate wirelessly with each other and with other units such as speakers and remote control units. A telephone unit communicates with a pager unit and also with the PC. An aggregate outline wireless coverage area 2 is shown in dashed outline about the edge of the house 1.

It can be seen that the various wireless networks within the house extend well beyond its physical boundaries. A similar situation exists for business WLAN, in which a number of employee computer terminals are distributed about a business' building, however the footprint or wireless coverage area of this network typically will extend beyond the building walls in all directions. In these cases it is relatively easy for a hacker to try to access these networks from outside the building, for example in an adjacent building, on the footpath or on the street in a car for example.

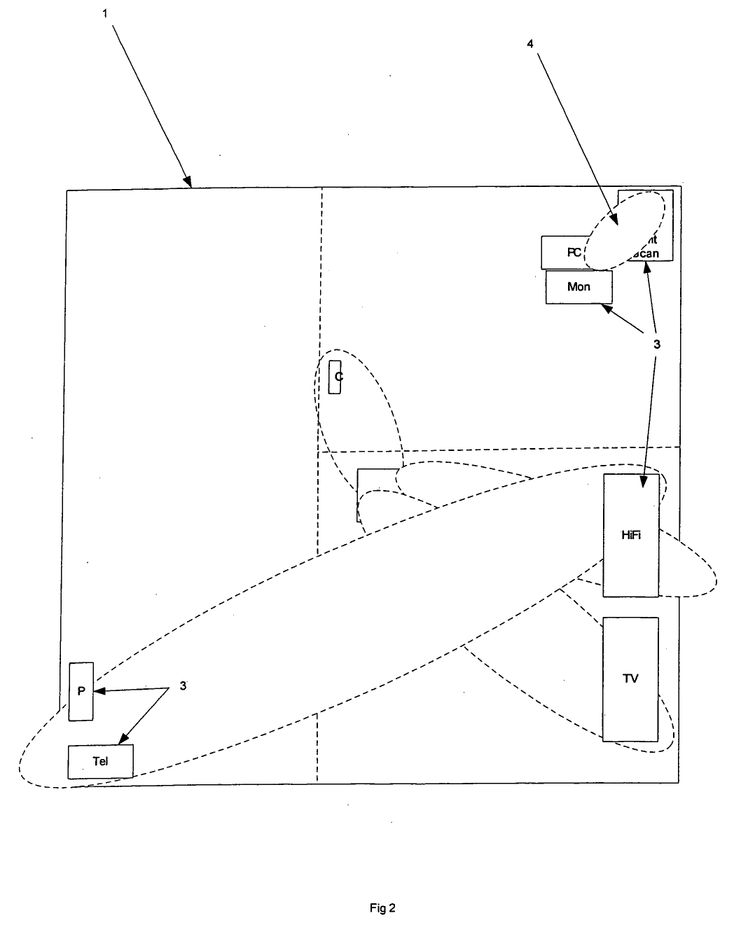

FIG. 2 shows the same house 1 and equipment 3, but with the various wireless networks arranged according to an embodiment. In particular the radiation patterns 4 of the various terminals 3 are constrained such that they just overlap the communicating (i.e. transmitting and receiving) terminals and the area in between. This is achieved by transmitting radio signals from each of the transmitting terminals in the form of a narrow beam directed at the receiving terminal. Furthermore the power of the transmission from each transmitting terminal is adjusted depending on the distance to the receiving terminals such that the footprint 4 or radiation pattern of the radio signals is sufficient for wireless communication to be achieved between the terminals. Thus the traditional omni-directional patterns of known arrangements are replaced by highly constrained radiation patterns or footprints 4 in order to minimise the opportunity for interference with the networks by third parties such as hackers. It can also be seen that the footprints 4 can be constrained or contained within the walls of the building 1, and thus require third parties to attempt to interface with the network from within the building, which is clearly more difficult. The measures of the embodiment can advantageously be combined with more traditional security measures such as authentication and encryption.

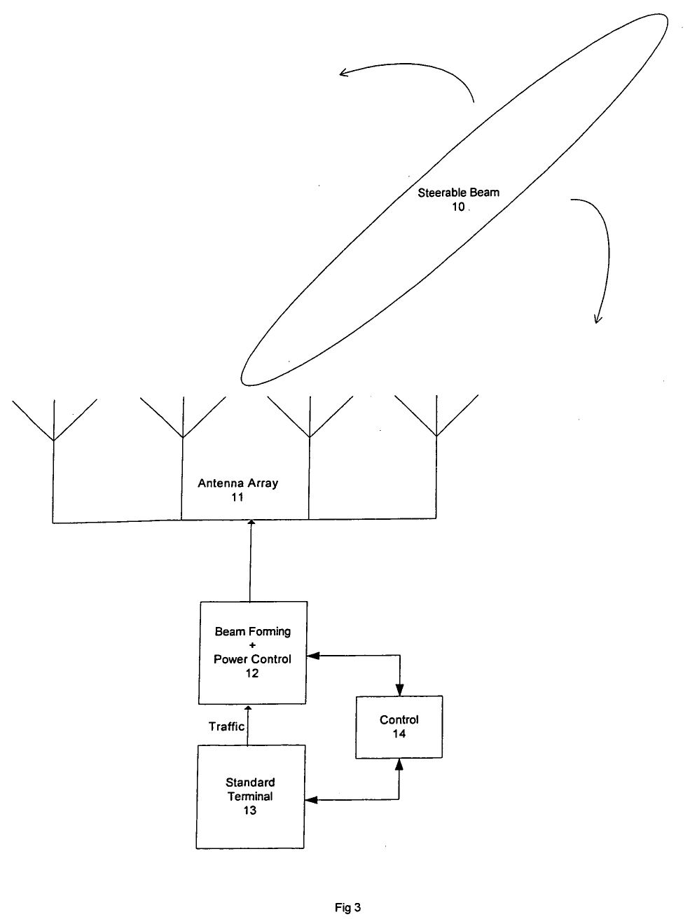

Referring to FIG. 3 the extra functionality for an otherwise standard terminal is shown schematically. The terminal produces a steerable beam or directed transmission radiation pattern 10 directed at another terminal and having a power level controlled according to the distance to this other terminal. The steerable beam 10 is produced using an antenna array 11 and a beam forming circuit as is known to those skilled in the art. Additionally a power control circuit is used to limit the transmission power of the steerable beam 10. This additional beam forming and power control circuitry 12 is added (schematically) to the standard terminal device 13, the beam forming and power control circuitry 12 being controlled by a notional controller 14. In “knowing” the direction and distance of the receiver terminal, the controller 14 directs the beam former and power control circuitry 12 to provide an appropriate transmission beam 10 which is narrowly directed at the receiving terminal and adjusted in terms of signal strength received by the receiver to be just enough to ensure a properly functioning wireless link.

Power control is a very well known mechanism and typically involves a feedback loop from the receiver to the transmitter, where the receiver reports back whether the transmitter is too quiet. In the case of CDMA applications, transmission power is maintained as low as necessary so as not to drown out other nearby terminals. ETSI (http://www.etsi.org) standards such as GSM and UMTS/3G mandate power control and define the higher level message exchanges required to report back the received power levels and to request increases or decreases in transmit power.

In the embodiment, the received signal level is maintained between two predetermined levels in order to ensure acceptable communications but at the same time not to allow the signal strength to become excessive and thus the “beam” to significantly “overshoot” the receiving terminal.

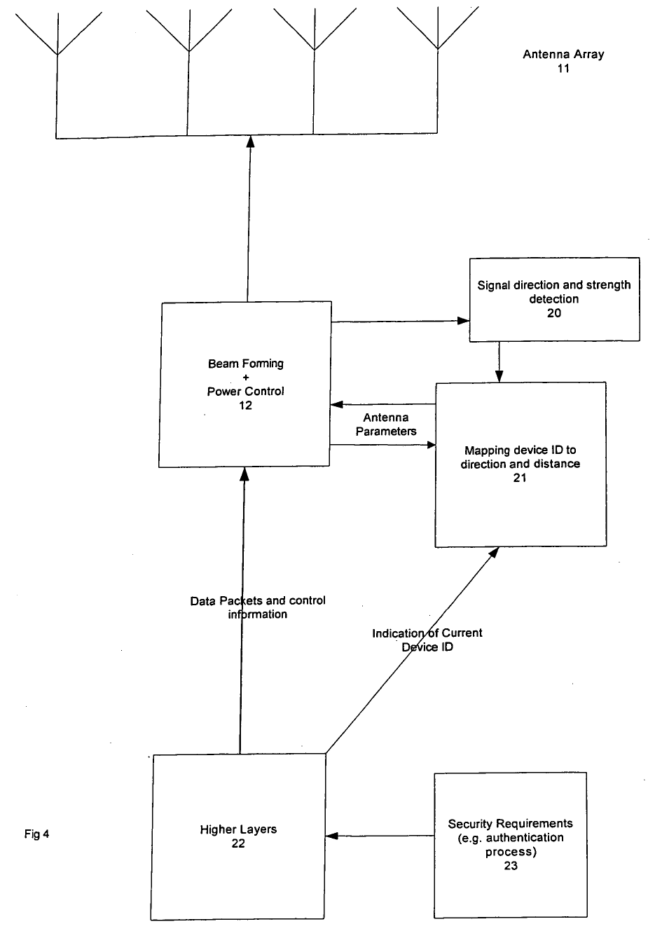

A practical architecture for achieving this is shown in FIG. 4. A WLAN is formed by the terminal of FIG. 4 and one or more other terminals (not shown). The direction and distance of these other terminals relative to the terminal of FIG. 4 can be determined using signal direction and strength detection functions 20 as is known to those skilled in the art. This may be achieved by using any suitable polling protocol typically involving step changes in beam direction and then step reductions in signal strength to achieve an optimum transmission direction and power. This is then mapped to an identifier for the particular device and stored by the terminal in a mapping function 21.

When the terminal transmits information to another terminal, the receiving terminal's identifier is sent to the mapping device 21 which then instructs the beam forming and power control circuitry 12 to provide the appropriate transmission beam 10 from the antenna array 11. The mapping function 21 may simply comprise a table of terminal identifier and beam direction and power level which is used to control the beam forming and power control circuitry in a known manner. This function will typically be implemented at a higher level in the protocol stack for example an application or transport layer 22.

Alternatively, a look-up table, indexed by destination address, could be implemented in the MAC layer (layer 2, the link layer). The application/high layers send as instructions “send this packet to device X”. The MAC layer then looks through the table for device X's entry, and extracts information such as the direction in which device X lies (and/or the actual parameters that the physical layer would require to steer a beam that way) and a power level to just reach that device.

If the terminal has never transmitted to that device before, some initialisation is required. This could be user initiated with the user entering a relative location and distance. Alternatively, the terminal could do an omnidirectional transmission to handshake with the destination device first and authenticate it. Secure handshaking procedures are known and can be implemented here—for example that used if registering a new handset onto a DECT base station.

The information in the look-up table can be updated during operation, to reflect any relative movement by the two devices, as well as any changes in the radio propagation environment (e.g. interference, obstructions) which may require changes to the nominal power level.

Similarly the terminal will “know” which direction another terminal will transmit from and so can be arranged to only receive transmissions along predetermined paths, and not for example from a rogue terminal outside of these directions.

In addition to these measures, the terminal may also incorporate more traditional security measures such as authentication and encryption processes 23, again typically implemented at a higher layer 22.

Thus the embodiment can be implemented on a standard terminal using an antenna array, beamforming and power control circuitry and adaptation of the transport or application layer protocol 22, and for the MAC layer.

The terminal may also be arranged to direct a null in the antenna radiation pattern toward a transmission source. Such a source may be a third party source trying to “hack” into the wireless network, or alternatively may be a misbehaving or misperforming terminal causing performance difficulties for the network. In this case a null can be directed towards this terminal in order to minimise its effect on the network.

Any suitable WLAN network may be utilised, for example any of the IEEE 802.11™ family, ETSI's HiperLAN-2™, or Japan's HiSWANa™. Similarly, this security measure could also be implemented on a Personal Area Network (PAN) such as Blue Tooth™ for example.

Embodiments provide an improved method of increasing the security of a wireless network, in particular a WLAN or PAN, by appropriately limiting the wireless footprint of the network.

Alternative implementations involve mechanically adjusted/steerable antennas, and switching between fixed narrow beams to “line up” the receiving terminal.

The skilled person will recognise that the above-described apparatus and methods may be embodied as processor control code, for example on a carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional programme code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analog array or similar device in order to configure analog hardware.

The skilled person will also appreciate that the various embodiments and specific features described with respect to them could be freely combined with the other embodiments or their specifically described features in general accordance with the above teaching. The skilled person will also recognise that various alterations and modifications can be made to specific examples described without departing from the scope of the appended claims.

1. A wireless local area network comprising a first and a second terminal in wireless communication with each other, the first terminal arranged to transmit to the second terminal, said first terminal comprising:
a transmitter arranged to form a directed transmission radiation pattern depending on the relative location of said second terminal; and
a power controller arranged to control the power of said transmission depending on the relative location of said second terminal.

2. A network according to claim 1 wherein the second terminal is arranged to transmit to the first terminal and comprises:
a transmitter arranged to form a directed transmission radiation pattern depending on the relative location of said first terminal; and
a power controller arranged to control the power of said transmission depending on the relative position of said first terminal.

3. A network according to claim 1 wherein the transmitter is arranged to generate a narrow beam.

4. A network according to claim 1 wherein the transmitter is arranged to direct said pattern away from another transmission source.

5. A network according to claim 4 wherein the transmitter is arranged to form the pattern with a null.

6. A network according to claim 1 wherein the transmitter comprises a beam-former and an antenna array.

7. A network according to claim 6 wherein the transmitter comprises a mapping function which instructs the beam-former and power controller depending on the relative location of the second terminal.

8. A network according to claim 1 wherein the or each terminal comprises circuitry and/or software arranged to determine the relative location of the other terminal.

9. A network according to claim 1 wherein the power controller is arranged to communicate with the other said terminal to determine whether the transmission power level should be adjusted.

10. A network according to claim 9 wherein the power controller is arranged such that the signal strength received by the other terminal is maintained between two predetermined levels.

11. A terminal in a wireless local area network comprising at least two terminals in wireless communication with each other, said terminal comprising:
a transmitter arranged to form a directed transmission radiation pattern depending on the relative location of the other said terminal; and
a power controller arranged to control the power of said transmission depending on the relative position of the other said terminal.

12. A method of operating a wireless local area network to increase its security, the network comprising at least two terminals in wireless communication with each other; the method comprising:
directing the or each terminals transmission radiation pattern depending on the relative location of another terminal;
controlling the power of said radiation depending on the relative location of another terminal.
